(19) United States
(12) Patent Application Publication
(10) Pub. No.: US 2004/0231221 A1
(43) Pub. Date: Nov. 25, 2004

(54) Inflatable blind

(76) Inventor: Ronald D. Latschaw, Grants Pass, OR (US)

Correspondence Address: GODFREY & KAHN S.C., 780 NORTH WATER STREET, MILWAUKEE, WI, 53202, US

(21) Appl. No.: 10/790,629

(22) Filed: Mar. 1, 2004

Related U.S. Application Data
(63) Continuation-in-part of application No. 10/186,520, filed on Jul. 1, 2002, now Pat. No. 6,698,131.

(51) Int. Cl. A01M 1/00

(52) U.S. Cl. 43/1

(57) ABSTRACT

A blind allows an occupant to lie on his back in an inclined position. A pair of flaps cover the person and are easily openable when the person moves to a sitting position or extends his arms outside of the blind. The frame may be made from rigid or inflatable members that can be collapsed or deflated for compact storage and convenient transport. The blind is foldable, requires no assembly in the field, and may be carried on a person's back like a backpack.

### RELATED APPLICATIONS

This is a continuation-in-part application of U.S. patent application Ser. No. 10/186,520, now U.S. Pat. No. 6,698,131 filed on Jul. 1, 2002, and claims the benefits provided under 35 U.S.C. § 120.

### FIELD OF THE INVENTION

The present invention relates generally to a portable shelters, and more particularly to portable hunting blinds that can accommodate a hunter in a supine position.

### BACKGROUND OF THE INVENTION

Historically, it has been recognized by hunters and animal watchers that some form of concealment is advantageous when pursuing animals, whether it be larger mammals or relatively smaller birds and the like. While mammalian sight is often not exceptionally keen, particularly in the case of grazing animals such as deer, birds nearly universally have excellent eyesight due to their often airborne environment. Accordingly, while such relatively crude concealment as tree stands and scent means of various sorts may be effective in hunting or viewing deer and the like, far more sophisticated blinds are required when bird hunting or bird watching, particularly in the case of waterfowl such as ducks and geese where typically little concealing cover is available in the typically marshy wetlands favored by such birds.

Blinds which may be set up in the field and covered with camouflage are known, with such blinds having hinged covers swingable to an open position for exposing a field of view for shooting. U.S. Pat. Nos. 3,848,352 and 3,323,530 issued to Chester M. Sayles and R. A. Smith, respectively, disclose such blind structures. The blinds of both of those patents incorporate top covers which may be biased to an open position with the aid of resilient elastic bands or cords. The cover of the Sayles patent is hingedly mounted on a vertical post at such a level that a person may sit under it. The cover opens only to a generally vertical, upright position in a direction against the wind. Thus, with the blind of Sayles oriented properly so that the hunter is facing waterfowl as they land in their normal direction against the wind, the wind would be opposing the opening of the cover. The flexible top cover of the Smith patent relies upon a trip cord for release, and utilizes elastic cords attached to the edge of the blind structure which also serves as the pivot axis for the top cover. With this arrangement, it is very questionable as to whether sufficient leverage would be exerted by the elastic cords to pull the top cover fully open, without continuing manual assistance from the person inside the blind.

U.S. Pat. Nos. 3,902,264 and 3,622,201 issued to Theodore N. Radig and No. 4,483,090 issued to Jackie D. Carper, respectively, also disclose portable blinds having coverings shiftable or collapsible to open positions, so as to expose a field of view to the person inside the blind. However, none of the aforementioned patents disclose a blind structure which would be suitable for covering a person lying on the ground in such a way that a hinged canopy could be rapidly actuated to an open position. U.S. Pat. Nos. 5,647,159 and D405,890 to Ronald D. Latschaw also disclose blinds having covers that are moveable to an open position but do not provide a collapsible portable blind.

U.S. Pat. No. 4,751,931 to Zibble et al. addresses the problem of lying on the ground. However, the blind does not provide much comfort against the elements. Further, the large swinging door may be difficult to use in windy conditions, and may attract attention.

Thus, there is a need for a flexible, portable blind which can be collapsed to a compact size for transport, is comfortable, and is rapidly and easily erected in the field.

### SUMMARY OF THE INVENTION

The blind of the present invention is generally a shell that can surround a person in a supine position. The shell is supported by a selectively collapsible frame. The frame may be formed by rigid members, inflatable chambers, or otherwise. The frame forms a cockpit in which a person can enter the blind. The cockpit is where the person's torso is located when the person is in a supine position. In one embodiment, a liner is connected to the frame for forming a wedge to support the person's torso in a slightly reclined supine position. To hide the person from sight, a pair of flaps are used to cover the cockpit. The flaps are connected to the shell with a fabric hinge. The flaps lay over the top of the open cockpit and easily open to the sides of the shell when the person moves from a supine position to a sitting position.

In one embodiment, the person's face can be covered by a mesh screen, and the bottom of the shell is lined with an insulating material. There may also be stubble straps located on the outside of the shell for attaching vegetation to the blind.

The portable blind can be transported by collapsing and folding the blind. A backpack assembly may be located on the bottom surface of the blind so it is easy to carry in the field.

Various other features, objects, and advantages of the invention will be apparent to those skilled in the art from the following detailed description including illustrative examples setting forth how to make and use the invention.

### BRIEF DESCRIPTION OF DRAWINGS

FIG. 1 is a perspective side view of the blind of one embodiment of the present invention in an open non-collapsed position;

FIG. 2 is a perspective side view of the blind of FIG. 1 having one flap in a closed position;

FIG. 3 is a prespective, partially exploded view of the collapsible frame used to support the blind of FIG. 1;

FIG. 3A is a detail view of an alternative embodiment of the head rest portion of the collapsible frame;

FIG. 4 is a perspective side view of the blind shown in FIG. 1 with a portion of the frame shown in a disassembled state;

FIG. 5 is a plan view of the blind of FIG. 1, with the flaps not shown in the view for ease of viewing the interior construction;

FIG. 6 is a partial side cross-sectional view of the blind of FIG. 1;

FIG. 7 is a rear elevation of the blind of FIG. 1;

FIG. 8 is an isolated view of the one of the flaps used to cover the blind shown in FIG. 1;

FIG. 9 is a bottom elevation of the blind of FIG. 1, showing one embodiment of the backpack assembly;

FIG. 10 is a perspective side view of the blind of FIG. 1 as it is being assembled from the collapsed position; and

FIG. 11 is the blind of FIG. 1 shown in a collapsed position on a person's back.

FIG. 12 is a perspective side view of the blind of an additional embodiment of the present invention in an open non-collapsed position;

FIG. 13 is partial view of the blind shown in FIG. 12, wherein the side flaps are in an open position;

FIG. 14 is a perspective view of the blind of FIG. 12, with flaps open to expose the blind interior;

FIG. 15 is a perspective view of the blind of FIG. 12, with the shell shown in phantom to reveal the inflatable members;

FIG. 16 is a plan view of the blind of FIG. 12, showing the inflatable members in phantom;

FIG. 17 shows the blind of FIG. 16, with the upper flaps in an open position to reveal the blind interior;

FIG. 18 shows the blind of FIG. 17, having the wedge door partially open to reveal the inflatable member located in the wedge;

FIG. 19 is a side elevational view of the blind of FIG. 12, showing the inflatable members and side openings in phantom;

FIG. 20 is front elevational view of the blind of FIG. 12, showing an inflation device connected to a port on an inflatable member;

FIG. 21 is rear elevational view of the blind of FIG. 12, showing an inflation device connected to a port on an inflatable member;

FIG. 22 shows the blind of FIG. 19 wherein the inflatable members are in a deflated state; and

FIG. 23 shows the blind of FIG. 12 in partial side cross-section wherein an inflation device is being used to inflate each inflatable member.

### DESCRIPTION OF THE PREFERRED EMBODIMENTS

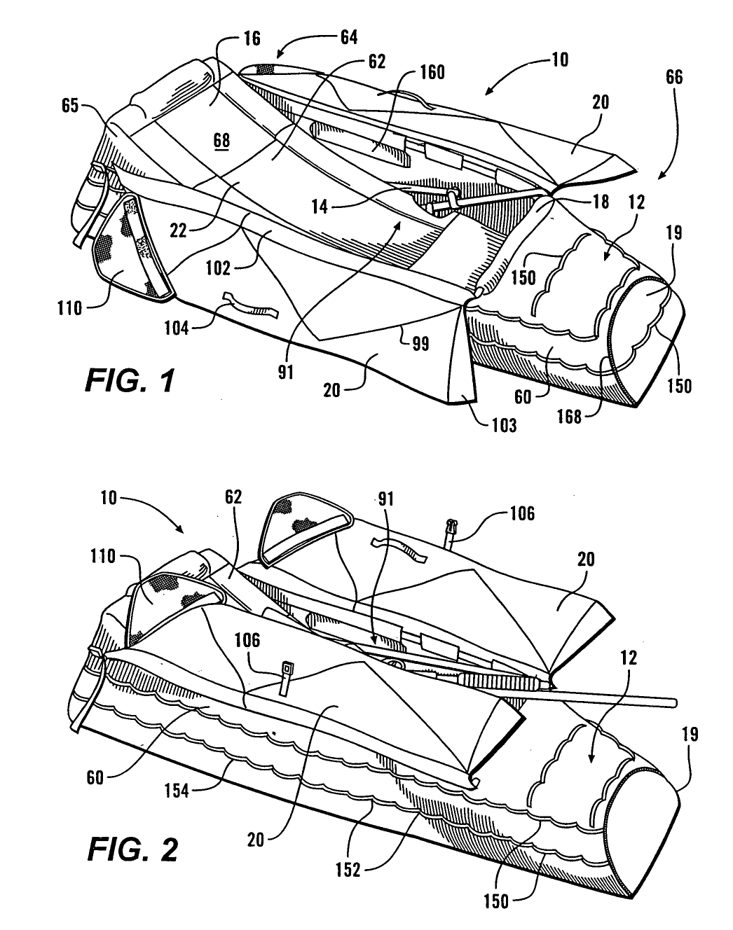

One embodiment of the present invention is the collapsible blind 10 shown in FIG. 1. The blind 10 is generally constructed from a fabric shell 12 that is supported by a collapsible frame 14. When the frame 14 is in a fully extended position as shown, the blind 10 takes on a casket-like appearance. A person can easily enter the blind 10 and position himself in a comfortable and practical supine position. A head rest 16 is inclined upward from the floor of the blind, and a gun rest 18 is provided by frame 14. The person's feet and other gear may fit in the large foot box located at the end 19 located opposite the head rest 16. A pair of flaps 20 are used to cover the opening 22 of blind 10 to hide the person. Flaps 20 can be easily opened as the person sits up or extends his or her arms.

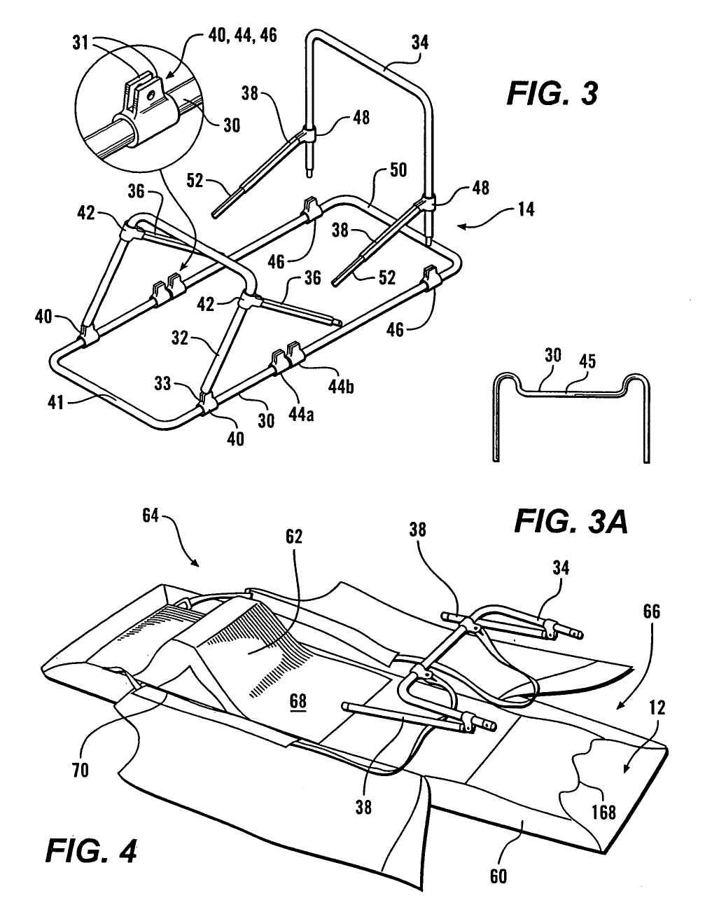

The frame 14 provides the primary structural support for the shell 12. Referring to FIG. 3, frame 14 is generally constructed from certain frame components: a ground piece 30, a head rest 32, a gun rest 34, a pair of braces 36, and a pair of telescoping braces 38. Ground piece 30 is a rectangular piece wide enough to accommodate the average person sitting therein. Head rest 32 is an a U-shaped piece that is rotatably connected to ground piece 30 at a short distance from one end, end 41. Preferably, brackets such as nylon brackets 40 are used to make the rotatable connection. Brackets 40 wrap around the circumference of ground piece 30, and have a pair of upwardly angled fins 31 for receiving a bolt and a self-locking nut 33 extending from an end of head rest 32. Of course, other arrangements of the pieces to form the frame 14 may be used without departing from the invention.

The head rest 32 may be selectively held in an upward position with respect to ground piece 30 using braces 36. Braces 36 are rotatably connected to head rest 32 with brackets 42. (Brackets 42, 44a, 44b, 46 and 48 discussed herein may be the same type as bracket 40 or other configuration.) The opposite end of brace 36 is also rotatably connected to ground piece 30 at brackets 44a. Preferably this connection can be released with relative ease so that the head rest 32 can be selectively collapsed against ground piece 30. In one embodiment, head rest 30 has a dropped middle 45 at a top portion of the brace (see FIG. 3A). Dropped middle 45 is designed to accommodate a cushioning pad described herein.

Gun rest 34 is also a U-shaped piece that is rotatably connected to ground piece 30 at a short distance from one end, end 50. Preferably, brackets such as nylon brackets 46 are used to make the rotatable connection. The gun rest 34 is selectively held in an upward position with respect to ground piece 30 by tension in the shell 12. Braces 38 are rotatably connected to gun rest 34 using brackets 48. The opposite ends of braces 38 are also rotatably connected to ground piece 30 at brackets 44b. Each brace 38 is telescoping, and has a snap button 52 locking mechanism to keep it in an extended position. The brace can be shortened by depressing snap button 52 to allow the gun rest to fold down toward ground piece 30.

Ground piece 30, head rest 32 and gun rest 34 preferably have radiused corners so as not to unduly stress the fabric shell 12 but other shapes could be used. Frame 14 may be constructed from a tubular material such as high-tempered aluminum or other shapes and materials. The frame aluminum material has the characteristics of having a good strength to weight ratio, being noncorrosive, and being capable of supporting the person's torso weight at head rest 32.

Referring now to FIG. 4, shell 12 is generally constructed from an outer casing 60 and a partial inner liner 62. Preferably, the casing 60 and liner 62 are made from a tough, water proof fabric such as 900 denier polyester with a polyurethane coating. The casing 60 floor may be constructed from the same fabric or a different fabric such as an 1800 denier polyester with a waterproof coating. Of course, other suitable materials could be used to construct the casing 60 and liner 62.

As shown in FIGS. 1, 2, 4, and 5, casing 60 and liner 62 are constructed to receive frame 14 in a disassembled state. In the upper portion 64 of blind 10, liner 62 is propped up during assembly to form a wedge 65 (see FIG. 1). Wedge 65 is a “hammock” style rest where the torso of a person will lie against when occupying blind 10. Further, the interior volume of wedge 65, accessible by a zipper closure or the like, is useful for storing and transporting decoys, clothing, etc., when the blind is in a semi-collapsed state. In the lower portion 66 of blind 10, the liner joins together with casing 60 so that the person's legs and feet will lie on the ground. In one embodiment, some type of insulation such as closed cell foam is provided between the casing 60 and liner 62 in the lower portion 66 so that the person is less affected by cold and/or rough ground. Likewise, liner 62 located in the upper portion of blind 10 may be backed with an insulator such as closed cell foam. Because the upper portion 64 of liner 62 is separated from casing 60 to form the wedge 65, liner 62 may be backed by a secondary liner (not shown) to enclose the closed cell foam underneath the top surface 68 of this portion of liner 62. Padding 69 such as closed cell foam is connected to the top section 67 of shell 12, and wrapped around and secured to gun rest 34. The padding 69 will protect a gun barrel's ventilated rib from being scratched or damaged and helps to maintain the position of the gun.

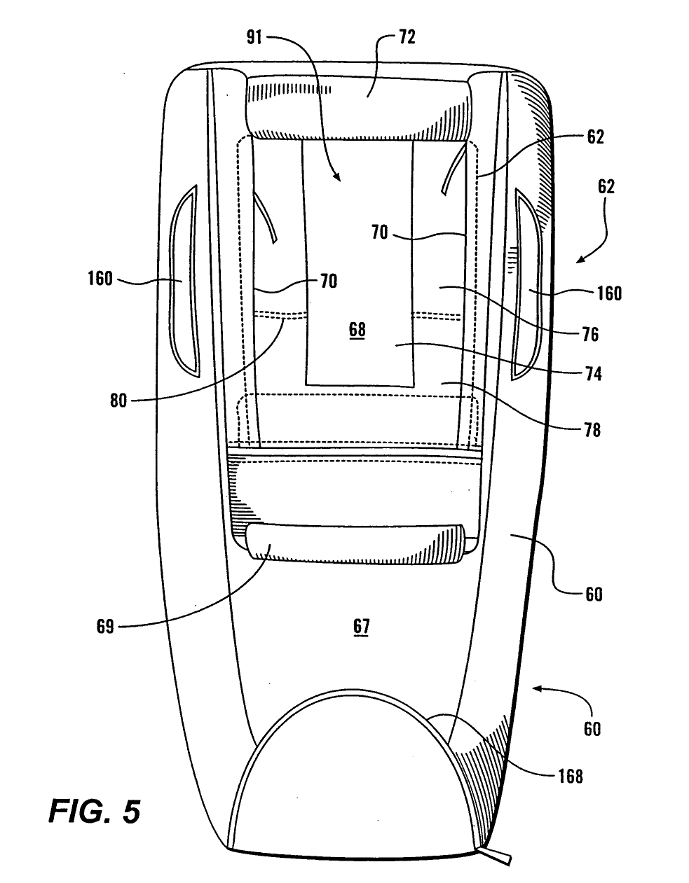

Referring now to FIGS. 4 and 5, the structure of upper portion 64 is described more fully. In one embodiment of blind 10, the top surface 68 has the following features. First, a zipper 70 is placed near each side of blind 10. When zippers 70 are completely unzipped, the person can gain access to the inside of wedge 65 to assemble the frame 14, take down the head rest or to use the storage space. Second, a padded head rest 72 made from a relatively thick piece of closed-cell foam may be located at the head rest 32. This padded head rest may be encased between a liner 62 and a fabric covering sewn thereto. Third, a pocket 74 may be sewn onto top of liner for storing items such as shotguns, flags, hunting licenses, and maps. The insulation attached to the liner 62 may be between zippers 70. The insulation may be one solid piece, or may be attached in segments for desired flexibility. For example, FIG. 5 shows the insulation connected to a first segment 76 and a second segment 78. Further, there is a flexural joint 80 formed at the small area separating the segments 76, 78.

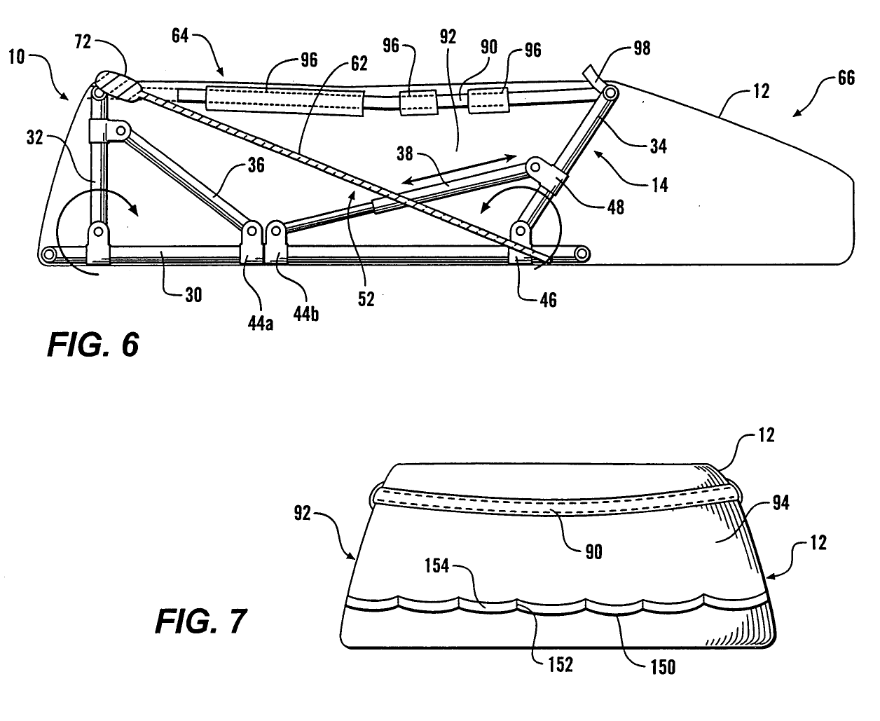

Referring now to FIGS. 6 and 7, the relationship between the shell 12 and frame 14 in an assembled position is shown. Generally, a strap 90 is connected to the gun rest 34 and is pulled taught so that shell forms a cockpit 91. Strap 90 keeps the sides 92 from sagging, and helps to support gun rest 34. Strap 90, made from nylon webbing or the like, is stitched or otherwise attached to the back side 94 and extends along both sides 92 of the cockpit 91 so that it can be connected to gun rest 34. On each side 92, strap 90 is fed through sleeves 96, that may be closed with hook and loop fasteners or other closing devices such as snaps. The strap end 98 is secured to the gun rest 34 with an “H” buckle or other securing device.

When the blind 10 is assembled and the flaps are closed, most of the frame 14 cannot be viewed past liner 62. There are apertures (not shown) in liner 62 at points where braces 38 extend toward the gun rest 34. Access to the hidden portion of frame 14 may be obtained by opening zippers 70 as seen in FIG. 5.

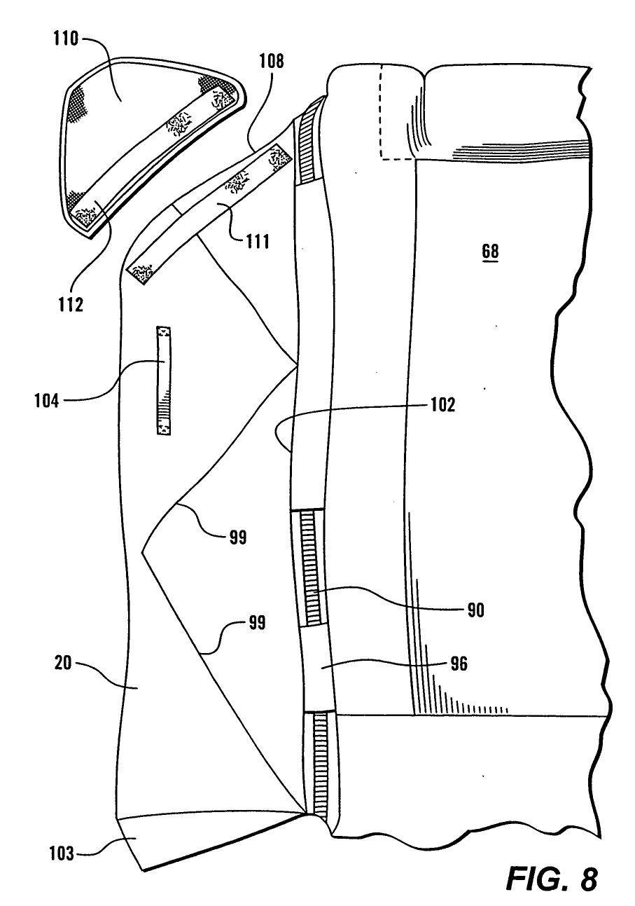

The flaps 20 may be seen in FIGS. 1, 2 and 8. In one embodiment, flaps 20 are generally constructed from closed cell foam lined with nylon fabric and covered on the exterior by the same fabric as shell 12. Quilting 99 may be used to keep the foam stationary with respect the fabric covering. The foam adds stiffness so that the flaps together form a lightweight door, and serves to insulate the hunter against cold weather. Additional stiffening members such as plastic cross or longitudinal members could be added. Each flap 20 has an elongated shape and is sized to adequately cover the cockpit 91 and the person occupying it. Each flap 20 is connected to the shell 12 with a fabric “hinge” 102 that may run the length of the flap. A handle 104 may be attached to the inner surface of each flap 20 so that the hunter can more easily close each flap 20. The flaps 20 can be buckled closed with a quick release buckle 106 or other closing device located on the exterior surface of the flaps 20, as seen in FIG. 2. An extra length of fabric 103 may extend beyond the quilted area containing the foam. Fabric 103 can drape downward onto the shell 12 so flaps 20 look somewhat integrated with the shell, at least from a bird's eye view.

To hide the person's head while viewing the sky for birds, a mesh screen 110 may be used. Preferably, a screen 110 is removably attached to the top edge 108 of each flap 20. A hook and loop material 111, 112 is most useful for this as it can be configured to allow screen 110 to be attached in varied positions. Other securing mechanisms could be used.

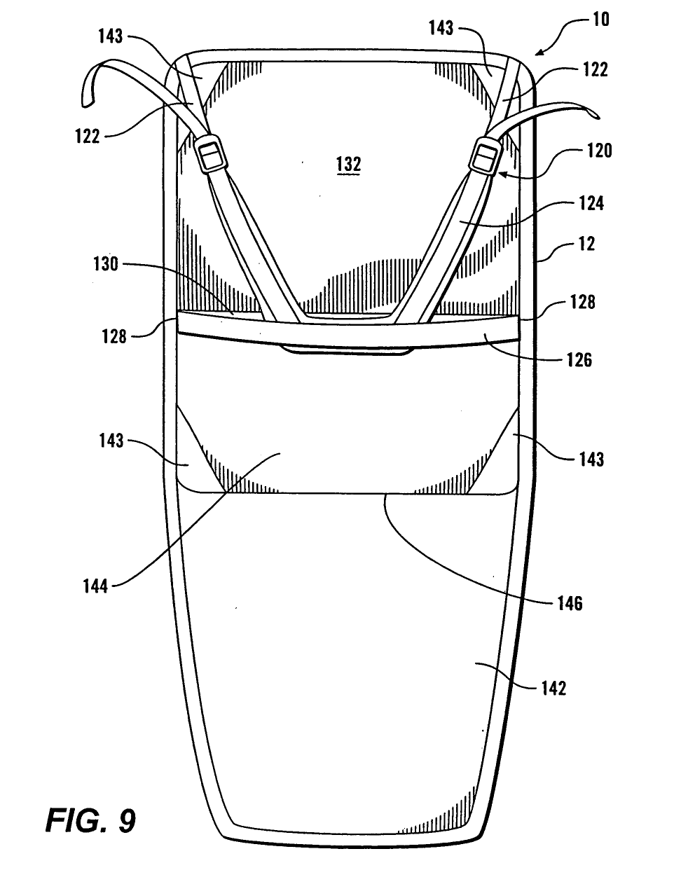

Referring now to FIG. 9, the bottom of blind 10 has a backpack assembly 120 connected thereto. The backpack assembly may be constructed from two adjustable straps 122 connected to a yoke such as U-shaped yoke 124. The bottom of yoke 124 is secured to a horizontal strap 126 that is sewn directly to the shell at each end 128. The attachment of strap 126 to shell 12 may be reinforced by an additional strap sewn directly to the bottom surface 132 of shell 12. There are other backpack assemblies that could be employed for the purpose of carrying the folded blind 10 on a person's back, and the invention should not be interpreted as being limited to the assembly shown in FIG. 9.

Referring still to FIG. 9, foam may be used to insulate floor or bottom surface 132 of blind 10 and is installed in two separate pieces. Alternatively, inflatable sections could be used. Foam pieces are indicated by reference numbers 142 and 144. This creates a fold “line” 146 where the blind 10 can easily bend. The fold line 146 is naturally located adjacent the edge of ground piece 30, which is approximately near the mid-length point, but may extend closer to the foot box. Further, for added durability, the corners of the surface 132 may be reinforced with a fabric piece 143. This is used to prevent undue wear to the shell 12 caused by rubbing the ground piece 30 against the ground.

Referring now to FIGS. 1, 2 and 7, in one embodiment of the present invention, stubble straps 150 are applied to the exterior surface of blind 10. The purpose of the stubble straps 150 is to provide a way to attach grasses, branches or other vegetation to the exterior of the blind for increased camouflage. Stubble straps 150 may be made from continuous strips of nylon webbing or the like, stitched periodically to shell 12 at stitches 152. This will leave segments 154 for sliding the vegetation therethrough.

Referring to FIGS. 1 and 5, optional flap doors 160 may be located on each side of the cockpit so that the person can extend his arms out the side when lying in the blind to flag waterfowl. Preferably, the flaps are hinged at the top so that if open, rain is deflected away from the flap opening. In addition, a door may be located at end 19. A zipper 168 is preferably added for access to the foot box portion of blind 10. The zipper 168 access makes it easier to clean this area or access items stored in the foot box. Of course, other zippers or hook and loop fastened flaps could be added throughout the blind if desired.

In operation, the blind 10 is fully extended as seen in FIGS. 1 and 6. In this position, a person may climb into the open cockpit area and lie down so his feet are in the foot box, head is on head rest 16, and torso is against wedge 65. The person closes the flaps 20 so he may view the sky trough mesh screens 110. If desired, vegetation can be placed into stubble straps 150 before the person is positioned inside blind 10.

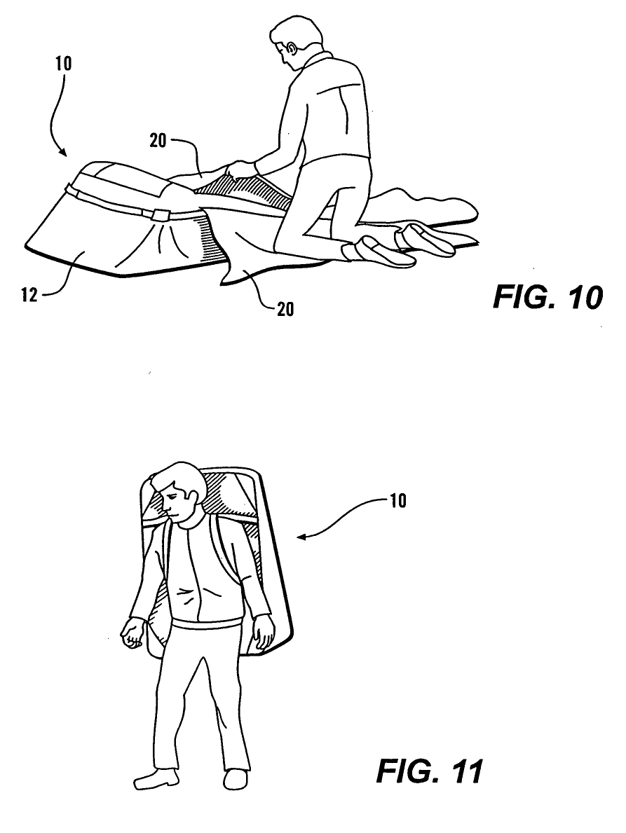

Referring to FIGS. 10 and 11, to transport the blind, the person depresses the snap button 52 located on each telescoping brace 38, and pulls the gun rest 34 toward head rest 32. Prior to this step, the person may unzip a zipper 70 on surface 68 and store decoys or other items inside wedge 65. The flaps 20 are then buckled shut, and the foot box or end 19 is folded over the flaps 20 until it reaches the head rest 32. End 19 may be temporarily secured against head rest 32 by tying an elastic band (not shown) around stubble straps adjacent to the end 19 and head rest 32. Other means of securing end 19 to the head rest 32 may be used. The blind 10 can now be carried on the person's back by placing the yoke 124 over his shoulders.

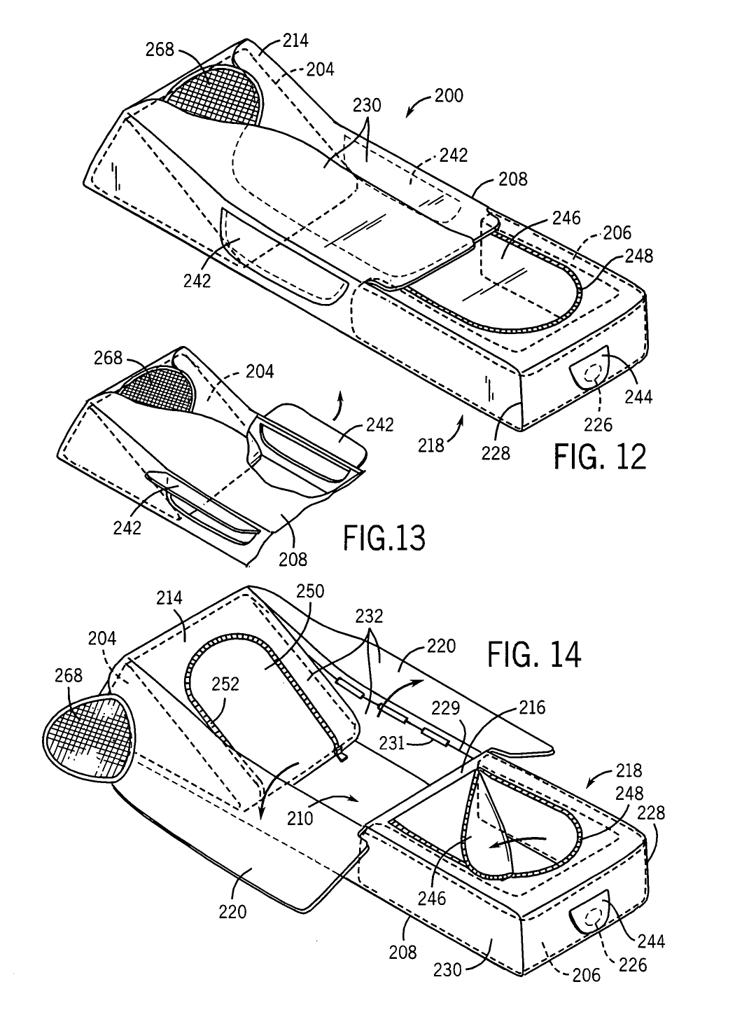

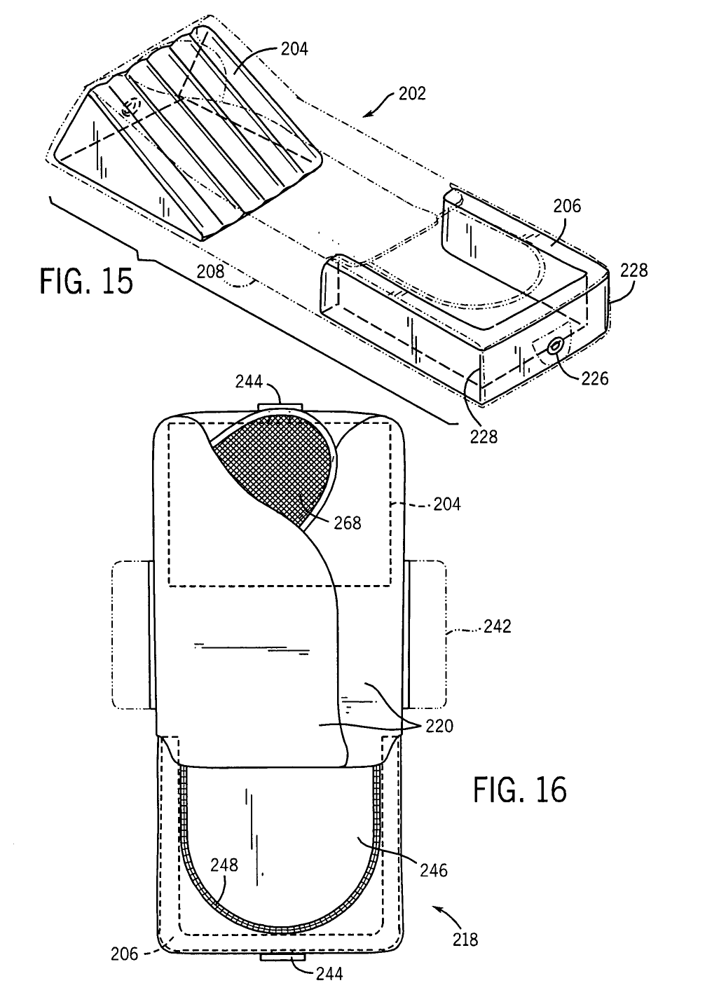

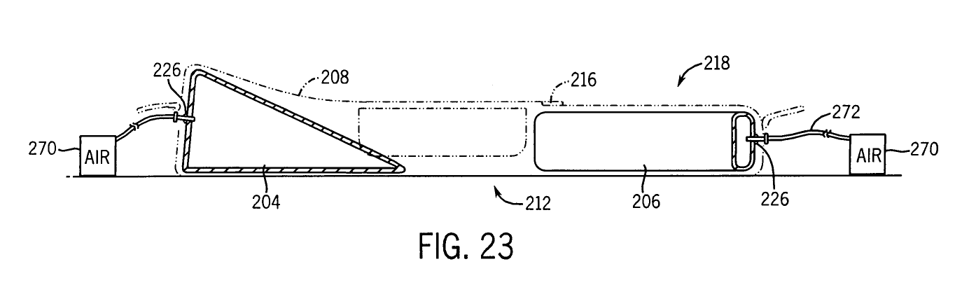

One alternative embodiment of the present invention is depicted in FIGS. 12 through 22. The blind of this embodiment, referred to as blind 200, has a flexible, inflatable frame instead of a rigid frame. Referring to FIGS. 14 and 15, blind 200 is generally constructed from a surrounding shell 208 supported by a frame 202. Frame 202 has two separate inflatable members 204, 206. When frame 202 is completely deflated, blind 200 may be rolled up or folded. Therefore, it is even more compact than the previously described embodiment, blind 10. The ability to become more compact may fit the needs of people that have limited storage or vehicle space. When frame 202 is inflated, and the shell 208 is fully spread out on the ground, a person may comfortably lie within the shell cockpit 210. To transport blind 200 to and from the field, it can be folded at a mid-section 212 and carried on the person's back, similar to blind 10, see FIGS. 22 and 23.

Referring to FIGS. 12 and 14, side perspective views of blind 200 are shown. Blind 200 presents the advantage of being relatively easy to transport on public transportation such as an airplane. Similar to the previous embodiment of blind 10, a head rest 214 is inclined upward from the floor of the blind, and a gun rest 216 is provided by a reinforced span of fabric located between the sides of blind 200. The person's feet and other gear may fit in the foot box 218 located at the end of blind 200, opposite of head rest 214. A pair of flaps 220 are used to cover the cockpit 210 to hide the occupant. Flaps 220 can be easily opened as the person sits up or extends his arms.

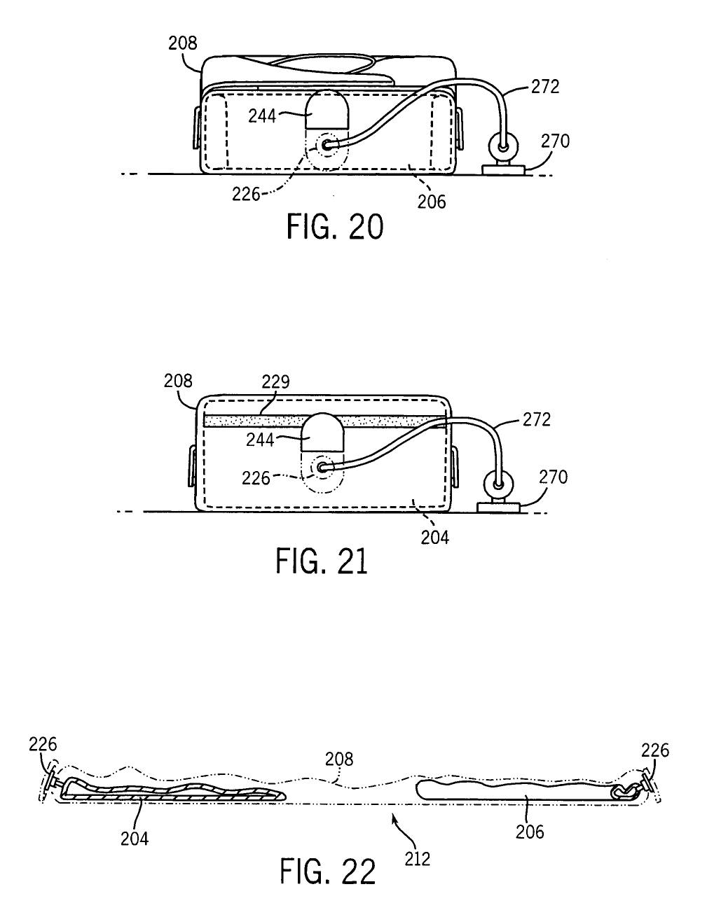

Referring to FIG. 15, the frame 202 provides the primary structural support for the shell 208. Frame 202 has two members, a wedge-shaped inflatable member 204 and a U-shaped inflatable member 206. Each member 204, 206 is preferably constructed from a flexible plastic or rubber material which may be fabric reinforced. Each member 204, 206 has an inflation valve 226 that may receive an air pump as shown in FIGS. 20, 21 and 23. Inflatable member 204 may have a “quilted” appearance as shown, or a smooth surface. Quilting has the benefit of creating a more flexible surface, which typically cradles the torso better than a smooth surface. Inflatable member 206 may be constructed from a single U-shaped bladder, or a multi-chambered bladder (not shown). The multi-chambered bladder would preferably have flexible joints at each corner 228 of foot box 218, and have air flow between the separate chambers so that only one air valve is necessary. Member 206 may have rounded edges as shown, or edges that are more squared in appearance.

Preferably, as in the previous embodiment of blind 10, secondary structural support may be achieved by placing some adjustable straps 229 through sleeves 231 that are located along the upper interior surface of each side of blind 200, in a manner similar to that shown in FIG. 6. However, rather than having the straps 90 extend from gun rest 34 and looping around head rest 32 as seen in FIGS. 6 and 7, the strap would form a complete loop. In particular, a strap 229 would extend through a sleeve (not shown) coinciding with the underside of gun rest 216, around the exterior surface of head rest 214, and through sleeves 231 spaced along each interior side of cockpit 210, see FIGS. 14 and 21. Strap 229 may be tightened so that gun rest 216 can support the barrel of a gun or other weapon without too much sagging. Strap 229 is also used to keep the sides of cockpit 210 from sagging.

The features of shell 208 are shown in FIGS. 12-23 to generally differentiate blind 200 from blind 10. However, many aspects of shell 208 are the same as that of blind 10, even if they are not illustrated. Therefore, lack of certain details in the depiction of blind 200 serves to simplify the understanding of its construction, and is not intended to limit the disclosure thereof.

As in the previous embodiment of blind 10, the shell of blind 200 is generally constructed from an outer casing 230 and a partial inner liner 232, see FIGS. 12 and 14. Preferably, the casing 230 and liner 232 are made from a fabric such as 420 denier nylon. The floor of casing 230 may be constructed from the same fabric that was used with blind 10, or a different fabric such as 1800 denier polyester with a waterproof coating. Another option is to make the bottom exterior surface 240 (see FIG. 19) from a waterproof material such as polyvinyl chloride. Of course, other durable fabrics and designs could be used to construct the casing 230 and liner 232.

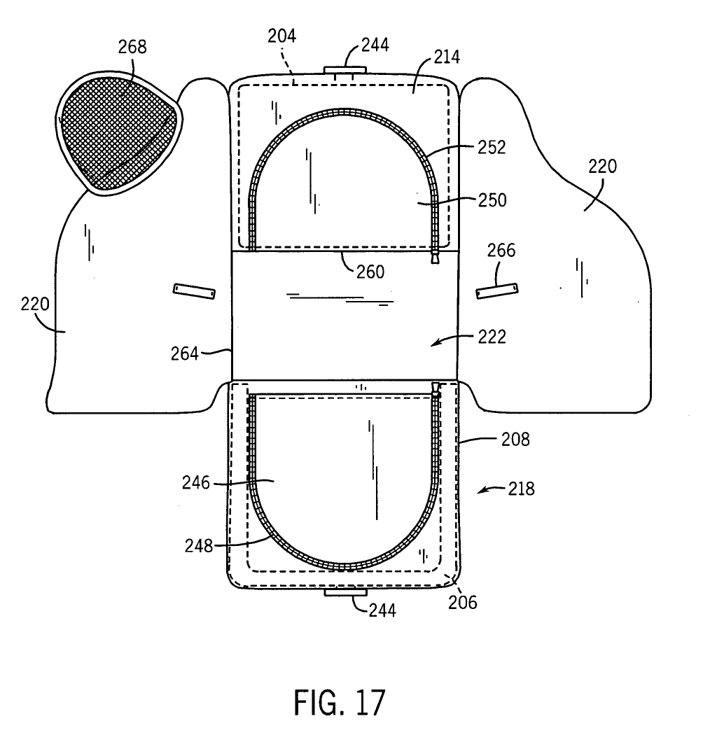

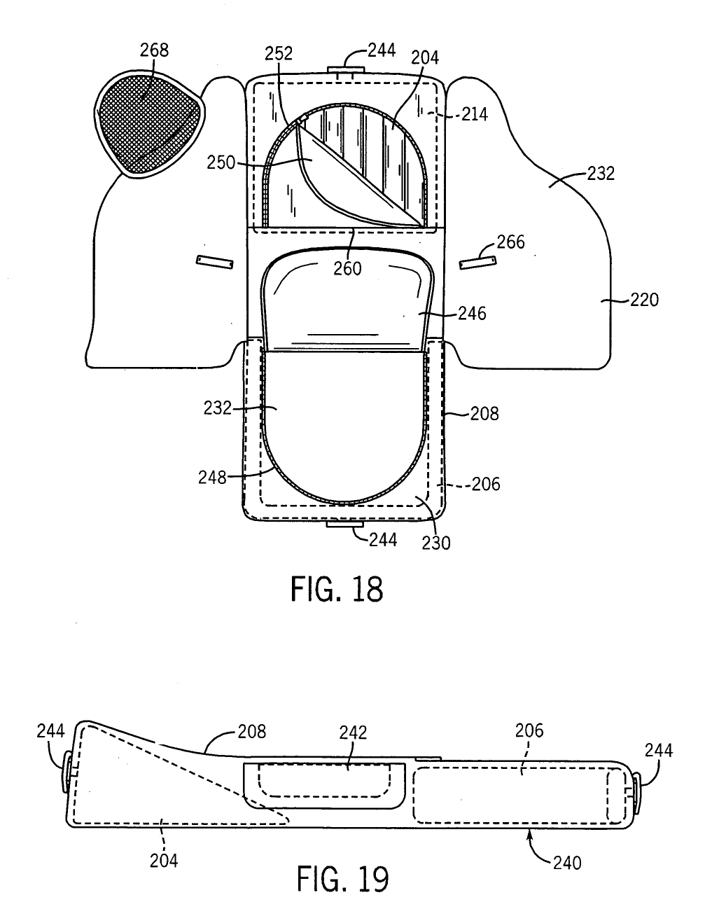

As best seen in FIGS. 14 and 17, a door 246 may be located over foot box 218 for access to the foot box portion of blind 200. Preferably, a zipper 248 is used to selectively open and close the door 246. As shown in FIG. 18, a second door 250 is located on head rest 214 to allow insertion or removal of inflatable member 204, as described below. A zipper 252 is preferably used to selectively open and close the door 250. Other zippered or hook and loop fastened flaps could be added throughout the blind if desired.

Casing 230 and liner 232 are constructed to receive inflatable members 204 and 206 in a deflated state. Referring to FIG. 15 in the head rest 214 of blind 200, inflatable member 204 is a wedge, and the liner 232 is constructed to contain member 204 so that when member 204 is inflated, it cannot move freely within the cockpit of blind 200. Preferably, the door 250 is attached to a panel so that together, they form a rectangular panel member 260. Each side of panel 260 is sewn to casing 230 to create a volume that is large enough to hold member 204. Likewise, in the foot box portion of blind 200, the liner 232 joins together with casing 60 so that it holds member 206 in proper position. An opening (not shown) may be located in the liner 232 adjacent the foot box portion to allow removal and insertion of a deflated member 206.

Flaps 220 are constructed in the same way as flaps 20 of blind 10. Thus, flaps 220 are generally constructed from closed cell foam lined with nylon fabric and covered on the exterior by the same fabric as shell 208. Quilting (not shown) may be used to keep the foam stationary with respect the fabric covering. The foam adds stiffness so that the flaps together form a lightweight door, and serves to insulate the hunter against cold weather. Additional stiffening members such as plastic cross or longitudinal members could be added. Each flap 220 has an elongated shape and is sized to adequately cover the cockpit and the person occupying it. As best seen in FIG. 17, each flap 220 is connected to the shell 208 with a fabric “hinge” 264 that may run the length of the flap. A handle 266 may be attached to the inner surface of each flap 220 so that the occupant can more easily close each flap 220. The flaps 220 can be buckled closed with a quick release buckle (not shown) or other closing device located on the exterior surface of the flaps 220. An extra length of fabric may extend beyond the quilted area containing the foam, as described for blind 10.

To hide the person's head while viewing the sky for birds, a mesh screen 268 may be used. As in blind 10, the screen 268 may be removably attached to the top edge of each flap 220. A hook and loop material is most useful for this as it can be configured to allow screen 268 to be attached in varied positions. Other securing mechanisms could be used.

Referring to FIGS. 12-13, optional flap doors 242 may be located on each side of the cockpit so that the occupant can extend his arms out the side when lying in the blind to flag waterfowl. As in the previous embodiment, the flap doors 242 are hinged at the top so that if open, rain is deflected away from the flap door opening. Flaps may be used to cover the air valves 226. In particular, flap doors 244 cover the air valves 226 for each inflatable member 204, 206 (see FIGS. 16 and 19).

In the floor of the blind 200, some type of insulation such as closed cell foam may be placed between casing 230 and liner 232 so that the hunter is less affected by cold and/or rough ground. As previously explained for blind 10, the foam may be installed in two separate pieces to create fold line where the blind 200 can easily bend. Alternatively, inflatable chambers could be used.

The bottom of blind 200 preferably has a backpack assembly like the one used with blind 10, see FIG. 9. Of course, other types of carriers could be used, such as an over-the-shoulder strap. Further, as in the previous embodiment of blind 10, stubble straps (not shown) may be applied to the exterior surface of blind 200.

In operation, typically members 204, 206 are inflated with some type of air pump 270 prior to going into the field, or possibly, prior to loading blind 200 into a vehicle for transport to the field. Inflatable members 204 and 206 may be inflated by a single air pump 270 that is attached to each air valve 226 by adaptor tubing 272, see FIGS. 20-23. However, if desired, the members may be inflated by mouth or by other means. Once members 204, 206 are inflated, the blind 200 may be folded over and carried on the back as shown in the previous embodiment of blind 10. Once in the field, if not before, straps 229 may be tightened to tighten the sides of cockpit 210 and gun rest 216.

For more complete deflation, the air pump may be used to later remove air from each member 204, 206, or the air valves 226 may be opened and each member squeezed to deflate the members, see FIG. 22.

While the invention has been described with reference to certain embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

What is claimed is:

1. A blind comprising:
a shell adapted to generally surround an occupant in a supine position;
a selectively collapsible frame for supporting the shell, wherein the frame and shell form a cockpit having an upper section and a lower section, and opposite sides; and
wherein the frame includes a first inflatable member adapted to support the occupant's torso at the upper section.

2. The blind of claim 1 further including a second inflatable member to support the shell at the lower section.

3. The blind of claim 2 wherein the second inflatable member creates a foot box. The blind of claim 1 wherein the second inflatable member is U-shaped to create a foot box at the lower section.

4. The blind of claim 1 wherein the first inflatable member is wedge-shaped.

5. The blind of claim 1 further including a strap extending along each interior surface of the sides of the cockpit to prevent the sides from sagging.

6. The blind of claim 5 further including a gun rest extending between the sides of the cockpit, adapted to support a gun.

7. The blind of claim 1 further including a backpack assembly on a bottom surface of the shell.

8. A blind comprising:
a shell adapted to generally surround a person in a supine position;
a selectively collapsible frame for supporting the shell, wherein the frame and shell form a cockpit;
at least one flap for covering the cockpit and for hiding the person, the at least one flap connected to the shell so that it is openable when the person moves from a supine position to a sitting position; and
wherein the frame comprises a first inflatable member and a second inflatable member.

9. The blind of claim 8 wherein the first inflatable member is wedge-shaped and the second inflatable member is U-shaped.

10. A frame for use with a fabric blind shell comprising:
a first inflatable member adapted to support a torso of a person; and
a second inflatable member adapted to suspend the shell over legs of the person.

11. The frame of claim 10 wherein the first inflatable member is wedge-shaped.

12. The frame of claim 10 wherein the second inflatable member is U-shaped.

13. A blind comprising:
a shell adapted to generally surround a person in a supine position;
a selectively collapsible frame for supporting the shell, wherein the frame and shell form a cockpit, and wherein the frame includes a pair of telescoping braces;
at least one flap for covering the cockpit and for hiding the person, the at least one flap connected to the shell so that it is openable to the sides of the shell when the person moves from a supine position to a sitting position; and
a separate enclosed compartment within the cockpit that functions as a selectively accessible storage space that items stored within the separate enclosed compartment cannot move freely within the cockpit.

14. The blind of claim 13 further comprising a pair of flaps.

15. The blind of claim 13 further including a screen attached to the at least one flap to allow the person to view prey while remaining under the flap.

16. The blind of claim 13 further including a liner for forming a wedge to support the person's torso in a slightly reclined supine position; wherein the wedge is enclosed to comprise the separate enclosed compartment.

17. The blind of claim 13 further including insulation on the bottom surface of the shell to insulate the person from the ground.

18. The blind of claim 13 wherein the frame includes a head rest and an opposite gun rest at the cockpit opening.

19. The blind of claim 13 further including stubble strips attached to the shell.

20. The blind of claim 13 further including a backpack assembly on a bottom surface of the shell.

21. A blind comprising:
a shell adapted to generally surround a person in a supine position;
a selectively collapsible frame for supporting the shell, wherein the frame and shell form a cockpit;
a liner connected to the frame for forming a wedge to support the person in a slightly reclined supine position, wherein the wedge is a separate compartment within the cockpit, the wedge having a selectively accessible interior volume adapted for storing items such that the items are not free to move about the cockpit; and
a pair of flaps for covering the cockpit and for hiding the person, the flaps connected to the shell so that they easily open to sides of the shell when the person moves from a supine position to a sitting position.
